(19) United States
(12) Patent Application Publication
(10) Pub. No.: US 2020/0309204 A1
(43) Pub. Date: Oct. 1, 2020

(54) GEAR SHIFTING COUPLING FOR A VEHICLE TRANSMISSION

(71) Applicant: AUDI AG, Ingolstadt (DE)

(72) Inventor: Jürgen KIESEWETTER, Weißenburg i. Bay (DE)

(73) Assignee: AUDI AG, Ingolstadt (DE)

(21) Appl. No.: 16/770,734

(22) PCT Filed: Nov. 26, 2018
(86) PCT No.: PCT/EP2018/082567

§ 371 Date: Jun. 8, 2020

(30) Foreign Application Priority Data
Dec. 11, 2017 (DE) 10 2017 222 346.4

(51) Int. Cl. F16D 23/02; F16H 63/30

(52) U.S. Cl. CPC F16D 23/02; F16H 2063/3093; F16H 63/30

(57) ABSTRACT

A gear shifting coupling for a vehicle transmission, having a transmission shaft having a shaft-fixed synchronizer body, on the outer gear teeth of which a sliding sleeve is axially guided using its inner gear teeth, wherein the sliding sleeve is brought into toothed engagement with outer gear teeth of a floating gear wheel in an axial movement in a shifting state, to establish a torque transmission between the transmission shaft and the floating gear wheel and wherein the toothed engagement between the sliding sleeve inner gear teeth and the floating gear wheel outer gear teeth is subject to play, specifically with a tooth flank play.

The invention relates to a gear shifting coupling for vehicle transmission according to the preamble of claim 1.

In a conventional dual-clutch transmission, in the driving mode, a first interrupting clutch is shifted to transmit force and a driving gear is engaged, the gear wheel set of which is loadbearing for a torque transmission. A further driving gear is preselected, the gear wheel set of which is still load-free. During a shifting procedure, the first interrupting clutch is disengaged and a second interrupting clutch is shifted to transmit force, whereby the gear wheel set of the preselected driving gear is loadbearing for a torque transmission. Such a dual-clutch transmission is fundamentally constructed in the gear wheel space using the same technology as a manual shift transmission, in which a gear shifting coupling comprises a synchronizer body arranged shaft-fixed on a transmission shaft. A sliding sleeve is axially guided using its inner gear teeth on the outer gear teeth thereof. The sliding sleeve is brought in axial movement into toothed engagement with outer gear teeth of a floating gear wheel in a gear shifting procedure, in order to establish a torque transmission between the transmission shaft and the floating gear wheel. In a generic gear shifting coupling, the toothed engagement between the sliding sleeve inner gear teeth and the floating gear wheel outer gear teeth is subject to play with a rotational play. Upon the introduction of a torque and/or upon a load change, the tooth flanks of the sliding sleeve inner gear teeth and the floating gear wheel outer gear teeth facing toward one another strike against one another while consuming this rotational play.

The above rotational play or tooth flank play between the tooth flanks is required to ensure an operationally-reliable coupling of the floating gear wheel during the gear shifting procedure. However, if rotational oscillations are introduced or load changes occur, such a rotational play can result in clicking and rattling noises, especially in a dual-clutch transmission. The noises arise due to the striking against one another of the tooth flanks facing toward one another of the sliding sleeve inner gear teeth and the floating gear wheel outer gear teeth.

Such gear shifting couplings, in particular synchronous clutches, are known, for example, from DE 10 2014 213 133 B4 or from DE 195 45 519 B4.

A method for producing a sliding sleeve for a gear shifting coupling is known from DE 10 2007 059 843 A1. Accordingly, firstly a linear band strip is produced having gear teeth forming the inner gear teeth on one flat side and at least one longitudinal groove forming the outer groove on the opposing flat side. Forming is subsequently performed, during which the linear band strip is bent into a round shape to form a closed ring having the inner gear teeth and having the outer groove.

The object of the invention is to provide a gear shifting coupling for a vehicle transmission, in which clicking or rattling noises in the event of a load change in the vehicle transmission can be avoided in a structurally simple manner.

The object is achieved by the features of claim 1. Preferred refinements of the invention are disclosed in the dependent claims.

According to the characterizing part of claim 1, at least one damping spring is arranged between the sliding sleeve and the floating gear wheel, by means of which a striking movement of the tooth flanks facing toward one another is damped. Due to the damped striking movement, the clicking or rattling noises can be reliably reduced or prevented during the shifting procedure, since the striking on one another of the tooth flanks facing toward one another is damped by means of the damping spring.

The sliding sleeve of the gear shifting coupling is out of toothed engagement with the floating gear wheel outer gear teeth in a neutral position. In the neutral position, the damping spring is preferably disengaged from the floating gear wheel outer gear teeth and is thus nonfunctional. In a technical implementation favorable for installation space, the damping spring can be positioned and/or fastened on the inner gear teeth of the sliding sleeve. In a first embodiment variant, in the sliding sleeve shift position, viewed in a circumferential direction, it can be supported in an elastically yielding manner with opposing spring forces between tooth flanks facing toward one another of two adjacent teeth of the floating gear wheel outer gear teeth. During an occurring torque transmission and/or during a load change or during the introduction of rotational oscillations, the tooth flanks facing toward one another of the sliding sleeve inner gear teeth and the floating gear wheel outer gear teeth can impact on one another while building up elastic spring restoring forces.

The above functionality can preferably be effectuated by a damping spring implemented as a leaf spring. The at least one leaf spring can press with a spring flank in an elastically yielding manner against a tooth flank of the floating gear outer gear teeth facing toward the leaf spring. The damping spring preferably comprises a total of two leaf springs, the spring flanks of which press in an elastically yielding manner on tooth flanks of the floating gear wheel outer gear teeth facing toward one another.

With regard to a provision favorable for packaging of an installation space for the damping spring, at least one inner tooth can be omitted in the sliding sleeve inner gear teeth and damping springs can be arranged in place of it.

It can be preferable with regard to a smooth shifting procedure if the damping spring is not in contact with a tooth base of the floating gear wheel outer teeth, but rather is spaced apart therefrom by a free radial offset. Alternatively thereto, the damping spring positioned on the sliding sleeve inner gear teeth cannot support itself against the tooth flanks of the floating gear wheel outer gear teeth facing toward one another, but rather can be supported in an elastically yielding manner on the tooth base of the floating gear wheel outer gear teeth. In this case, the damping spring does not act in the circumferential direction, but rather in the radial direction.

In one preferred refinement, the damping spring can be designed so that, in the sliding sleeve shifting position and also when the gear shifting coupling is still load-free, the following state of affairs results: in this case, the damping springs can thus center the sliding sleeve and the floating gear wheel in relation to one another, so that all tooth flanks of the sliding sleeve inner gear teeth and the floating gear wheel outer gear teeth are spaced apart from one another via a centering play. Upon a load introduction into the shifted gear shifting coupling, the tooth flanks of the sliding sleeve inner gear teeth and the tooth flanks of the floating gear wheel outer gear teeth can strike (in a damped manner) against one another while completely consuming the centering play.

The above invention is applicable in particular in a dual-clutch transmission, in which, in the driving mode, a first interrupting clutch is shifted to transmit force and a driving gear is engaged, the gear wheel set of which is already loadbearing for a torque transmission, and also a further driving gear is preselected, the gear wheel set of which is still load-free. During a shifting procedure, the first interrupting clutch is disengaged and a second interrupting clutch is shifted to transmit force. A load change occurs in this case, upon which the gear wheel set of the preselected driving gear becomes loadbearing for a torque transmission. However, the load change takes place substantially free of clicking or rattling noises due to the damping spring.

Exemplary embodiments of the invention are described hereafter with the aid of the appended figures.

In the figures:

FIG. 1 shows a longitudinal half-section through a synchronous dual-clutch for a shifting transmission of a motor vehicle having a shaft-fixed synchronizer body, a shifting sleeve guided thereon via gear teeth, synchronizer rings, and floating gear wheel gear teeth arranged on floating gear wheels;

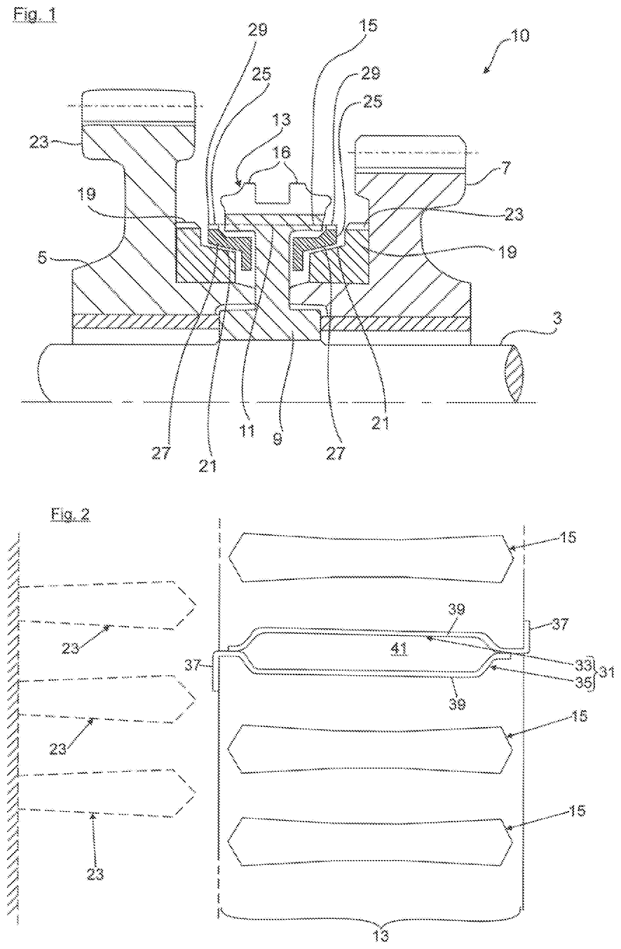

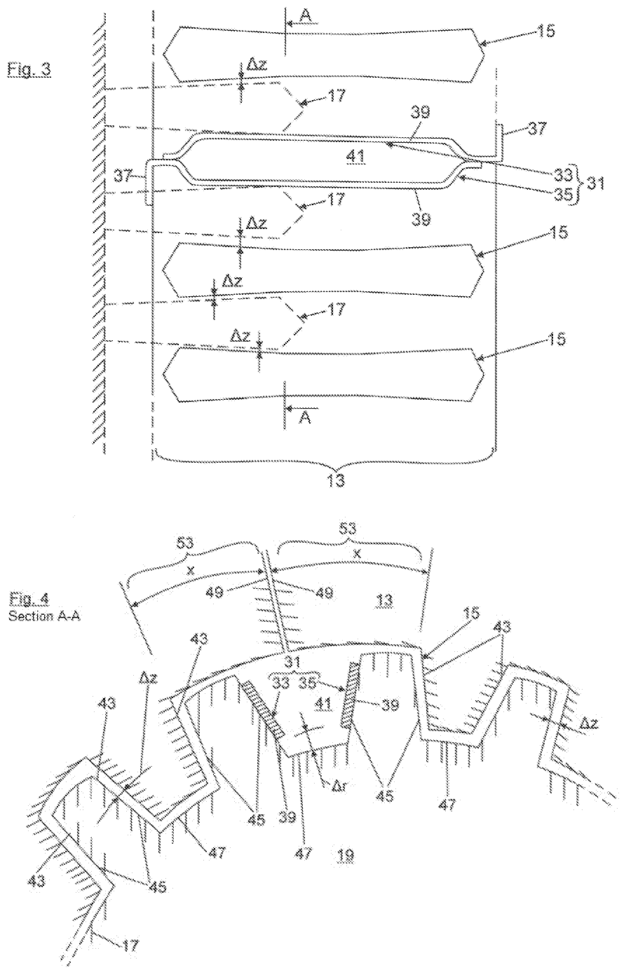

FIG. 2 shows a schematic partial view of the inner gear teeth of the sliding sleeve in a neutral position;

FIG. 3 shows a view corresponding to FIG. 2 in a shifting position of the sliding sleeve;

FIG. 4 shows a schematic illustration in partial section along the plane of section A-A from FIG. 3; and

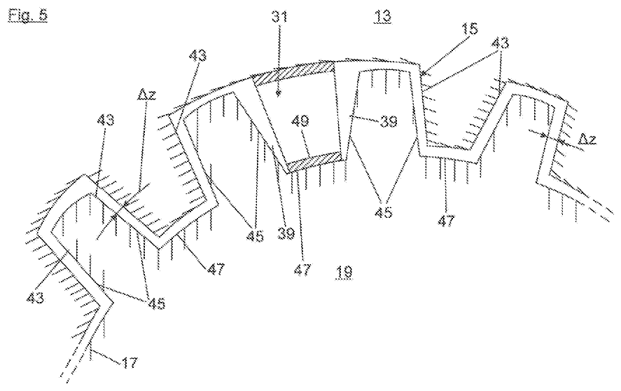

FIG. 5 shows a view corresponding to FIG. 4 according to a second exemplary embodiment.

An upper half of an essentially known synchronous dual clutch 1 for a vehicle transmission is shown in FIG. 1, which is arranged on a transmission shaft 3 between two floating gear wheels 5, 7.

The synchronous clutch 1 comprises a middle synchronizer body 9, which is held in a shaft-fixed manner on the transmission shaft, while the axially adjacent floating gear wheels 5, 7 are rotatably mounted on the transmission shaft 3 via needle bearings.

The synchronizer body 9 is provided with outer gear teeth 11, on which a sliding sleeve 13 is displaceably guided in the axial direction using its inner gear teeth 15. The sliding sleeve 13 can be displaced in a typical manner via a shift fork, which engages in an outer groove 16, of a shift device (not shown) from the middle position shown (i.e., the neutral position) to the left or to the right to shift a gear.

Each of the floating gear wheels 5, 7 bears a clutch body 19 having an outer cone 21 and outer gear teeth 23, which can be brought into toothed engagement with the sliding sleeve inner gear teeth 15.

Synchronizer rings 25 each having a friction cone 27 and locking gear teeth 29 are inserted between the clutch bodies 19 fixedly connected to the floating gear wheels 5, 7 and the synchronizer body 9, which rings are axially displaceably and pivotably guided to a limited extent on the synchronizer body 9 in a known manner. To shift a gear and/or to couple a floating gear wheel 5, 7 to the transmission shaft 3, the sliding sleeve 13 is axially displaced, wherein firstly synchronization is established via the corresponding synchronizer ring 25. Due to the synchronization, the locking gear teeth 29 of the synchronizer ring 25 become inactive and the sliding sleeve 13 can be engaged with the outer gear teeth 17 of the relevant floating gear wheel 5, 7 via the locking gear teeth 29 and beyond.

The inner gear teeth 15 of the sliding sleeve and, using dashed lines, the outer gear teeth 17 of the floating gear wheels 5, 7 are shown in FIGS. 2 and 3. They are out of toothed engagement in the sliding sleeve neutral position (FIG. 2) and are brought into toothed engagement in the sliding sleeve shifting position (FIG. 3). For better clarity, the locking gear teeth 29 of the synchronizer rings 25 are not shown in FIGS. 2 and 3. As is apparent from FIGS. 2 and 3, a damping spring 31, which is implemented using two leaf springs 33 and 35, is installed on the sliding sleeve inner gear teeth. The leaf springs 33, 35 are fastened using the axially outer spring base points 37 thereof on axially opposing end faces of the sliding sleeve 13. To provide installation space for the two leaf springs 33, 35, one inner tooth is omitted in the inner gear teeth 15 of the sliding sleeve 13 and the two leaf springs 33, 35 are arranged in place thereof.

The two leaf springs 33, 35 each have an elastically flexible spring flank 39, which are both curved outward in opposite directions to one another in the circumferential direction and delimit a free deformation space to the inside, into which the two spring flanks 39 can deform in the shifting state (FIG. 3). In the neutral position shown in FIG. 2, the two leaf springs 33, 35 and the sliding sleeve inner gear teeth 15 are out of toothed engagement with the floating gear wheel outer gear teeth and are solely in toothed engagement with the outer gear teeth 11 of the synchronizer body 9.

During a shifting procedure, the sliding sleeve 13 is brought into a play-subjected toothed engagement with the floating gear wheel outer gear teeth 17 in axial movement, in order to enable a torque transmission between the transmission shaft 3 and the floating gear wheel 5, as indicated in FIG. 3.

In FIGS. 3 and 4, the sliding sleeve 13 is shown in its shifting position, wherein the synchronous dual clutch 1 is still load-free, i.e., it is not yet subjected to a torque. In this case, the two leaf springs 33, 35 center the sliding sleeve 13 and the floating gear wheel 5 in relation to one another, so that the tooth flanks 43 of the sliding sleeve inner gear teeth 15 and the tooth flanks 45 of the floating gear wheel outer gear teeth 17 are spaced apart from one another via a centering play Δz.

In the event of a load introduction, the tooth flanks 43, 45 of the sliding sleeve inner gear teeth 15 and the floating gear wheel outer gear teeth 11 are brought to a stop with one another while consuming the centering play Δz and also while simultaneously building up a restoring force in the two leaf springs 33, 35. The striking movement of the tooth flanks 43, 45 is braked or damped in this case by the damping spring 31, so that clicking or rattling noises can be prevented when the tooth flanks 43, 45 strike against one another.

A second exemplary embodiment is shown in FIG. 5, in which the damping spring 31 is also implemented as a leaf spring. In contrast to the preceding figures, however, the damping spring 31 is not in elastically yielding contact with the tooth flanks 45 of the floating gear wheel outer teeth 11 in the shifting state, but rather with the tooth base 47 of the floating gear wheel outer gear teeth 11. In the preceding figures, in contrast, the damping spring 31 is spaced apart via a free radial offset Δr from the tooth base 47 of the floating gear wheel outer gear teeth 45.

The sliding sleeve 13 described in the preceding figures is preferably produced as follows: Firstly, a linear band strip is thus provided, which comprises gear teeth forming the inner gear teeth 15 on one flat side and a longitudinal groove forming the outer groove 16 on the opposing flat side. The band strip is then formed, i.e., bent in a round shape, into a ring shape, and joined together on its end-face band strip ends 49 (FIG. 4). The joining connection can be implemented by way of example as a dovetail connection, in which the band strip ends 49 are additionally welded to one another.

In the above-described production process, it is preferable if the gear teeth forming the inner gear teeth 15 do not extend directly up to the respective band strip end 49, but rather the gear teeth merge in the direction toward the respective band strip end 49 into a gear teeth-free, smooth-surfaced band section 53, as indicated in FIG. 4. Accordingly, the two band sections 53 extend over a length dimension x and they directly abut the respective band strip end 49. Moreover, the two gear teeth-free, smooth-surfaced band sections 53 extend on the same diameter as the tooth base of the inner gear teeth 15. An installation space for the damping spring 31 is provided in a manner simple to manufacture by means of the gear teeth-free, smooth-surfaced band sections 53.

1-12. (canceled)

13. A gear shifting coupling for a vehicle transmission, comprising:
a transmission shaft having a shaft-fixed synchronizer bod, on an outer gear teeth of which a sliding sleeve is axially guided using its inner gear teeth, wherein the sliding sleeve is brought into toothed engagement with outer gear teeth of a floating gear wheel in an axial movement in a shifting state, to establish a torque transmission between the transmission shaft and the floating gear wheel, and wherein the toothed engagement between the sliding sleeve inner gear teeth and the floating gear wheel outer gear teeth is subject to play, specifically with a tooth flank play and wherein during the torque transmission, the tooth flanks facing toward one another of the inner gear teeth of the sliding sleeve and the outer gear teeth of the floating gear wheel strike against one another while consuming the tooth flank play wherein at least one damping spring by which a striking movement of the tooth flanks facing toward one another is damped, acts between the sliding sleeve and the floating gear wheel.

14. The gear shifting coupling as claimed in claim 13, wherein the damping spring is attached to the inner gear teeth of the sliding sleeve, and/or in that the damping spring acts in the shifting state in a circumferential direction with opposing spring forces on opposing tooth flanks of two adjacent teeth of the outer gear teeth of the floating gear wheel, and in that during a torque transmission, the tooth flanks facing toward one another of the sliding sleeve inner gear teeth and the floating gear wheel outer gear teeth strike while building up an elastic spring restoring force, specifically with a damped or braked striking movement.

15. The gear shifting coupling as claimed in claim 13, wherein the damping spring comprises at least one leaf spring and/or in that the damping spring presses with a spring flank in elastically yielding manner against a tooth flank facing toward the leaf spring of the floating gear wheel outer gear teeth.

16. The gear shifting coupling as claimed in claim 13, wherein the damping spring comprises two leaf springs, the tooth flanks of which press in elastically yielding manner on tooth flanks, facing toward one another, of the outer gear teeth of the floating gear wheel.

17. The gear shifting coupling as claimed in claim 13, wherein to provide an installation space for the damping spring in the inner gear teeth of the sliding sleeve, at least one tooth is omitted and the damping spring is arranged in place thereof.

18. The gear shifting coupling as claimed in claim 13, wherein, in a neutral position, the sliding sleeve is out of toothed engagement with the floating gear wheel outer gear teeth and in that in the neutral position, the damping spring is nonfunctional.

19. The gear shifting coupling as claimed in claim 13, wherein the damping spring is spaced apart by a free radial offset from a tooth base of the floating gear wheel outer gear teeth.

20. The gear shifting coupling as claimed in claim 13, wherein the damping spring comprises a spring flank, which is supported in the shifting state in elastically yielding manner on a tooth base between two adjacent teeth of the floating gear wheel outer gear teeth.

21. The gear shifting coupling as claimed in claim 13, wherein in the shifting state and in the case of load-free gear shifting coupling, the damping spring centers the sliding sleeve and the floating gear wheel in relation to one another, so that all tooth flanks of the sliding sleeve inner gear teeth and the floating gear outer gear teeth are spaced apart from one another via a centering play.

22. The gear shifting coupling as claimed in claim 13, wherein the vehicle transmission is a dual-clutch transmission, in which, in the driving mode, a first interrupting clutch is shifted to transmit force and a driving gear is engaged, the gear wheel set of which is loadbearing for a torque transmission, and also a further driving gear is preset, the gear wheel set of which is still load-free, and in that during a shifting procedure, the first interrupting clutch is disengaged and a second interrupting clutch is shifted to transmit force, whereby the gear wheel set of the preselected driving gear is loadbearing for a torque transmission.

23. The gear shifting coupling as claimed in claim 13, wherein the sliding sleeve is produced from a linear band strip, which comprises gear teeth forming the inner gear teeth on one flat side, wherein the band strip is formed into a ring shape, i.e., bent into a round shape, and is joined together on its end-face band strip ends and in that the gear teeth forming the inner gear teeth merge in the direction toward at least one band strip end into a gear teeth-free, smooth-surfaced band section, which terminates directly at the band strip end, and in that the gear teeth-free, smooth-surfaced band section provides the installation space for the damping spring.

24. A method for producing a sliding sleeve for a gear shifting coupling as according to claim 13, comprising the following steps:
producing a linear band strip having gear teeth forming the inner gear teeth on one flat side and at least one longitudinal groove forming the outer groove on the opposing flat side, and
forming the linear band strip into a closed ring having the inner gear teeth and the outer groove.

25. The gear shifting coupling as claimed in claim 14, wherein the damping spring comprises at least one leaf spring and/or in that the damping spring presses with a spring flank in elastically yielding manner against a tooth flank facing toward the leaf spring of the floating gear wheel outer gear teeth.

26. The gear shifting coupling as claimed in claim 14, wherein the damping spring comprises two leaf springs, the tooth flanks of which press in elastically yielding manner on tooth flanks, facing toward one another, of the outer gear teeth of the floating gear wheel.

27. The gear shifting coupling as claimed in claim 15, wherein the damping spring comprises two leaf springs, the tooth flanks of which press in elastically yielding manner on tooth flanks, facing toward one another, of the outer gear teeth of the floating gear wheel.

28. The gear shifting coupling as claimed in claim 14, wherein to provide an installation space for the damping spring in the inner gear teeth of the sliding sleeve, at least one tooth is omitted and the damping spring is arranged in place thereof.

29. The gear shifting coupling as claimed in claim 15, wherein to provide an installation space for the damping spring in the inner gear teeth of the sliding sleeve, at least one tooth is omitted and the damping spring is arranged in place thereof.

30. The gear shifting coupling as claimed in claim 16, wherein to provide an installation space for the damping spring in the inner gear teeth of the sliding sleeve, at least one tooth is omitted and the damping spring is arranged in place thereof.

31. The gear shifting coupling as claimed in claim 14, wherein, in a neutral position, the sliding sleeve is out of toothed engagement with the floating gear wheel outer gear teeth and in that in the neutral position, the damping spring is nonfunctional.

32. The gear shifting coupling as claimed in claim 15, wherein, in a neutral position, the sliding sleeve is out of toothed engagement with the floating gear wheel outer gear teeth and in that in the neutral position, the damping spring is nonfunctional.
